(19) United States
(12) Patent Application Publication
(10) Pub. No.: US 2007/0013631 A1
(43) Pub. Date: Jan. 18, 2007

(54) Liquid crystal display driving methodology with improved power consumption

(75) Inventor: Chien-Sheng Yang, Jhudong Township (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/181,396

(22) Filed: Jul. 13, 2005

(51) Int. Cl. G09G 3/36

(52) U.S. Cl. 345/96

(57) ABSTRACT

The present invention uses a voltage swing waveform that changes the Vcom voltage level at the half-frame time to achieve a row inversion effect. As such, the Vcom swing frequency is equal to the frame refreshing rate. As Vcom is provided to the LCD panel for driving the pixels, the voltage swing between two polarities may partially or fully charge some parasitic capacitance in each of the pixels. By reducing the Vcom swing frequency, the power consumption associated with the parasitic capacitance can be substantially reduced. Furthermore, in the driving scheme of the present invention, one half of a frame time is used for driving all odd-numbered rows consecutively and the other half of the frame time is used for driving all even-numbered rows consecutively.

### FIELD OF THE INVENTION

The present invention relates generally to an active matrix liquid crystal display (AMLCD) device and, more particularly, to a method for driving thin-film transistor liquid-crystal display (TFT-LCD) devices.

### BACKGROUND OF THE INVENTION

Thin-film transistor liquid-crystal displays (TFT-LCDs) are well known in the art. A TFT-LCD panel comprises an upper substrate, a lower substrate and a liquid crystal layer disposed between the two substrates. The upper substrate comprises a transparent upper electrode made of indium tin-oxide (ITO) and a color filter layer to provide the colors in the displayed image. The upper electrode is connected to a common voltage known as Vcom. The lower substrate comprises a lower electrode layer defining an array of pixels arranged in rows and columns as shown in FIG. 1. Typically each pixel has a pixel electrode controlled by a switching device such as a thin-film transistor (TFT).

In a color LCD panel, each pixel is further divided into three color sub-pixels in R, G and B. Each color sub-pixel has a separate lower electrode. In a transflective color LCD panel, each color sub-pixel is further partitioned into a transmission area and a reflection area and each area may have a separate electrode. For simplicity, the present invention and the background of the invention will be described only in terms of pixels.

As shown in FIG. 1, the LCD panel 200 has a plurality of data lines 212 and a plurality of gate line 222 such that a pixel is substantially bounded by two adjacent data lines and two adjacent gate lines. The signals (Vdata) on the data lines are provided by one or more source drivers 210 and the signals (Vgate) on the gate lines are provided by one or more gate drivers 220. A control ASIC 230 is used to control both the source drivers and the gate drivers. The control ASIC 230 is also used to provide the common voltage Vcom on common line 252. A DC/DC converter 240 is generally used to provide electrical power to the control ASIC, the source drivers and the gate drivers.

An equivalent circuit of a pixel in an LCD panel is shown in FIG. 2a and a schematic representation of a pixel is shown in FIG. 2b. As shown in FIGS. 2a and 2b, the pixel 100 comprises a capacitor C_{LC} (110) which represents the capacitance in the liquid crystal layer between the upper electrode and the pixel electrode in the pixel 100. One end 114 of the capacitor 110 represents the upper electrode (common electrode) on the upper substrate, which is connected to the voltage level Vcom on a common line 252. The other end 112 represents the pixel electrode on the lower substrate and is electrically connected to a data line 222ₙ through a TFT. The TFT is switched on when a gate line signal Vgate is provided on the gate line 222ₙ. When the TFT is on, the voltage level V_{PIXEL} of the pixel electrode becomes substantially equal to the voltage level of the signal Vdata on the data line 212ₘ after the capacitance C_{LC} is charged. It is the voltage potential ΔV between V_{PIXEL} and Vcom that determines the state of the liquid crystal layer in the pixel 100. In general, the pixel electrode is also connected to one end of a charge storage capacitor C_{ST} (120) to reasonably retain the charge in the pixel and thus the voltage level on the pixel electrode after the gate line signal has passed. It is common practice that the voltage potential ΔV is maintained across the liquid crystal layer in the pixel at least one frame time before a new voltage potential is applied. The other end of the charge storage capacitor C_{ST} is connected to another common line 254 on the lower substrate. In some LCD panels, the common line 254 is electrically connected to the common line 252. In some other panels, the common line 254 is electrically connected to an adjacent gate line 222ₙ₊₁ (not shown).

In general, the voltage potential ΔV is maintained across the liquid crystal layer in the pixel at least one frame time (16.67 ms if the display refreshing frequency is 60 Hz) before a new voltage potential is applied. If the liquid crystal panel is used as a computer monitor, for example, the voltage potential on a particular pixel can be the same for a long time.

It is known in the art that if a substantially high voltage potential is applied over the liquid crystal layer for a long period of time, the optical transmission characteristics of the liquid crystal may change. This change may be permanent, causing an irreversible degradation in the display quality of the LCD panel. For this reason, voltage potential inversion is normally used to change a steady voltage potential into an alternating form. One of the voltage potential inversion schemes is to change the polarity of the voltage potential ΔV when a new row of pixels is driven by a gate line signal. This inversion scheme is known as row inversion as illustrated in FIG. 3. To achieve a row inversion effect, the voltage level of the Vcom is changed every “row” time. The change in Vcom in the alternating manner is also known as Vcom swing. The relationship between the Vcom swing and the gate line signal is shown in FIG. 4.

As can be seen from FIGS. 3 and 4, the common line voltage is required to change between two adjacent rows. Similarly, in a column inversion scheme, the common line voltage is required to change between two adjacent columns. In a frame inversion scheme, the common line voltage is required to change between two adjacent frames, as shown in FIG. 5. It is known that frame inversion may cause an undesirable effect of flickering.

In a display having M rows, the frequency of Vcom swing to achieve a row inversion effect is f=(M/2)×60 Hz, assuming the frame refreshing rate is 60 Hz. It is known that the power consumption related to charging and discharging a capacitor C to a voltage potential V with a frequency f is given by
Power consumption=f×C×V². (1)

In a display with a larger number rows, power consumption will increase proportionally. Thus, it would be advantageous and desirable to provide a method to reduce the power consumption while maintaining the same image quality of the LCD panel.

### SUMMARY OF THE INVENTION

The present invention provides a new method of achieving a row inversion effect. Instead of changing the Vcom voltage level M times per frame for achieving a row inversion effect in an LCD display having M rows, the same row inversion effect can be achieved by changing the Vcom voltage level only once per frame. Thus, the Vcom swing frequency f is equal to the frame refreshing rate. As Vcom is provided to the LCD panel for driving the pixels, the voltage swing between two polarities may partially or fully charge some parasitic capacitance in each of the pixels. This parasitic capacitance may be associated with the gate lines and the pixel electrodes. In particular, when the control elements in the LCD panel are made of low-temperature poly-silicon (LTPS), additional parasitic capacitance may exist between the Vdd, Vss electrodes of the switching elements in the lower substrate, and the common lines on the upper substrate. By reducing the Vcom swing frequency, the power consumption associated with the parasitic capacitance can be substantially reduced.

Instead of driving the pixel rows in an LCD panel consecutively with a different Vcom value, the present invention uses a control circuit to achieve a different driving scheme. In the driving scheme, according to the present invention, one half of a frame time is used for driving all odd-numbered rows consecutively and the other half of the frame time is used for driving all even-numbered rows consecutively.

The present invention will become apparent upon reading the description taken in conjunction with FIGS. 6 to 11.

### BRIEF DESCRIPTION OF THE DRAWINGS

FIG. 1 is a schematic representation of an LCD panel and a circuit for driving the panel.

FIG. 2a is an equivalent circuit of a pixel.

FIG. 2b is a schematic representation of the pixel.

FIG. 3 shows a row-by-row scanning sequence according to a prior art row inversion scheme.

FIG. 4 shows the waveform of the common line voltage in relation to the gate line signals in two consecutive frames, according to the prior art row inversion scheme.

FIG. 5 shows the waveform of the common line voltage in a prior art frame inversion scheme.

FIG. 6 shows a row driving pattern, according to the present invention.

FIG. 7 shows the waveform of the common line voltage in relation to the gate line signals in two consecutive frames, according to the present invention.

FIG. 8 shows the waveform of the common line voltage in relation to a plurality of frames, according to the present invention.

FIG. 9 shows another row driving pattern, according to a different embodiment of the present invention.

FIG. 10 shows the waveform of the common line voltage in relation to the gate line signals in two consecutive frames, according to the different embodiment of the present invention.

FIG. 11 is a block diagram showing an exemplary driving circuit for achieving the row driving pattern, according to the present invention.

### DETAILED DESCRIPTION OF THE INVENTION

In a typical LCD panel, a plurality of gate lines are used to provide gate line signals to separately drive a plurality of rows of pixels, and a plurality of data lines are used to separately provide data signals to a plurality of columns of pixels. The gate lines and the data lines are disposed on the lower substrate of the LCD panel. In a transmissive LCD panel, a pixel generally comprises a group of pixel electrodes with each pixel electrode associated with a color sub-pixel. In a transflective LCD panel, each color sub-pixel may comprise two or more sub-pixel electrodes. Each color sub-pixel generally comprises one or more separate charge storage capacitors disposed on the lower substrate. Thus, a large number of common lines are needed to be disposed on the lower substrate in order to provide a common voltage to the charge storage capacitors. In order to isolate the gate lines, the data lines and the common lines, one or more passivation layers are disposed, one on top of another, on the lower substrate. The passivation layers are also used for providing the charge storage capacitors. With this inherently complex circuit structure on the same lower substrate, there exist many different sources of parasite capacitance between the common lines and other circuit components such as gate lines, data lines, charge storage capacitors and pixel electrodes. This parasite capacitance also consumes power when the LCD panel is in operation.

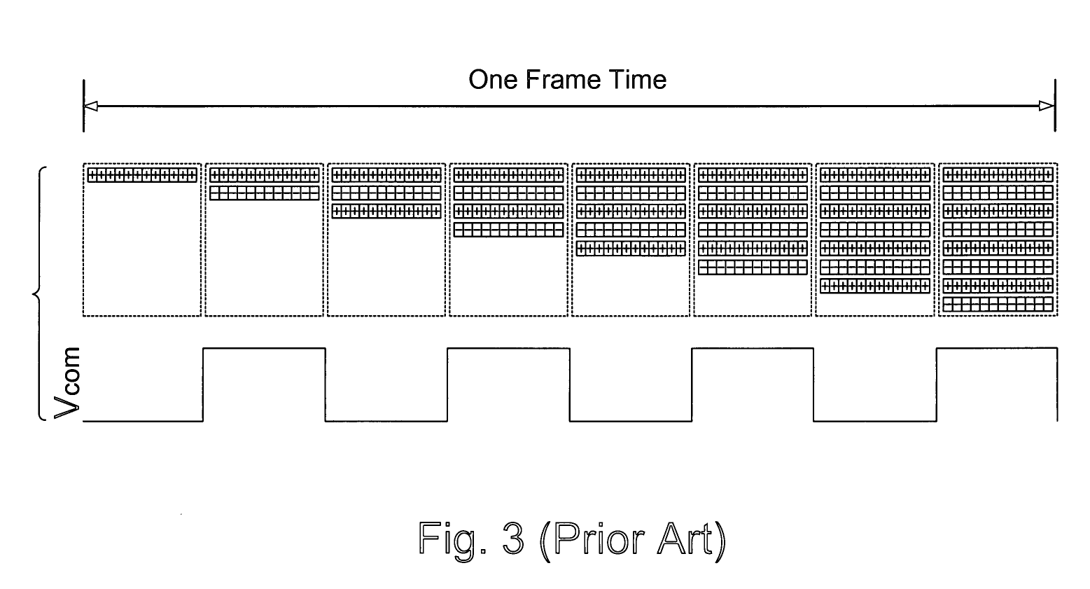

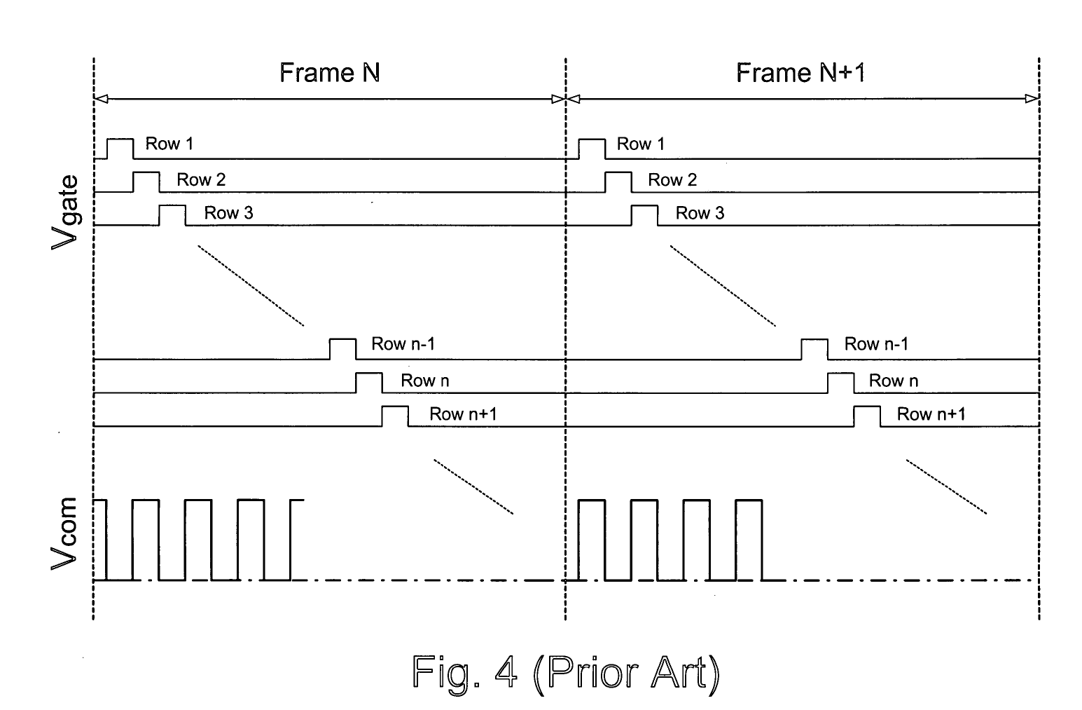

As can be seen from Equation 1, the power consumption associated with the Vcom swing and the parasite capacitance is directly proportional to the Vcom swing frequency. Thus, it is possible to reduce power consumption by reducing the frequency f of the voltage swing. In general, the frequency or the waveform of the Vcom swing is related to the inversion method used on the LCD panel. For example, in a row inversion scheme as shown in FIGS. 3 and 4, the Vcom swing frequency is directly proportional to the number of rows in the panel. In a column inversion scheme, the Vcom swing frequency is directly proportional to the number of columns in the panel. In frame inversion, the common line voltage is required to change only once every frame time. In these inversion schemes, the scanning of the gate line signals is the same in that the gate line signals are provided to the rows in a sequential manner. That is, the pixel rows are driven by the gate line signals consecutively.

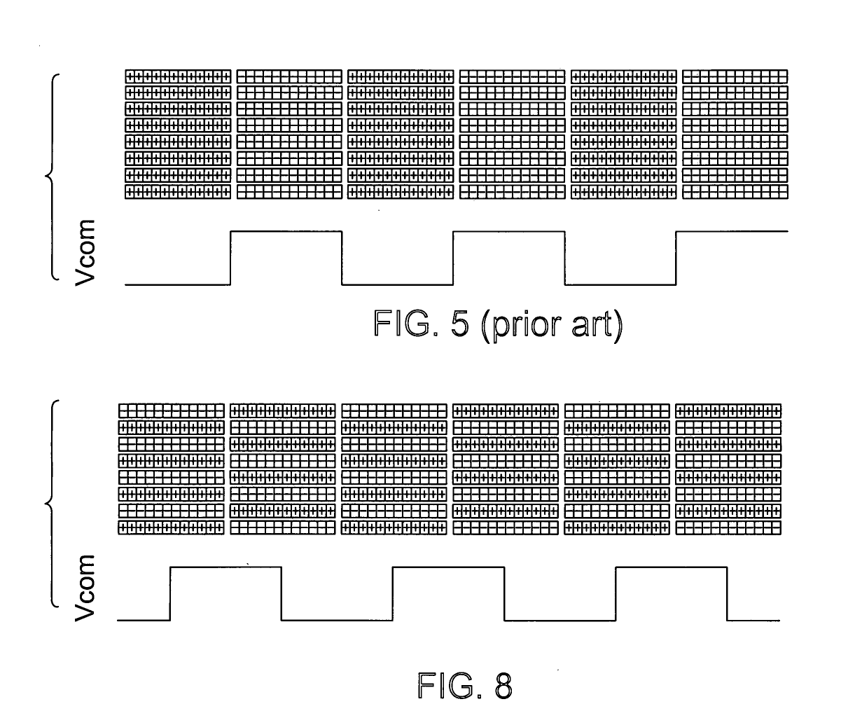

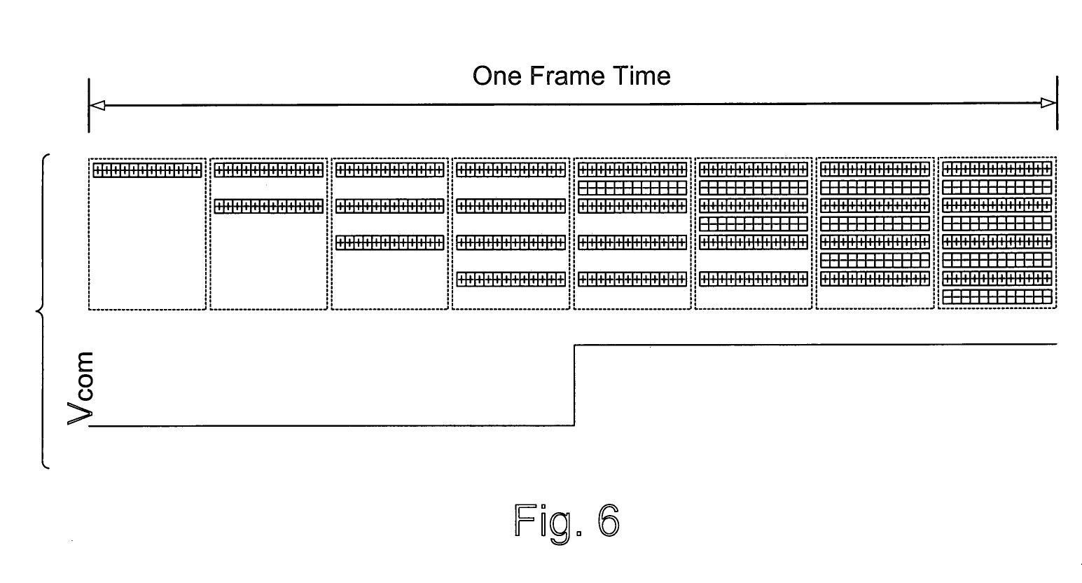

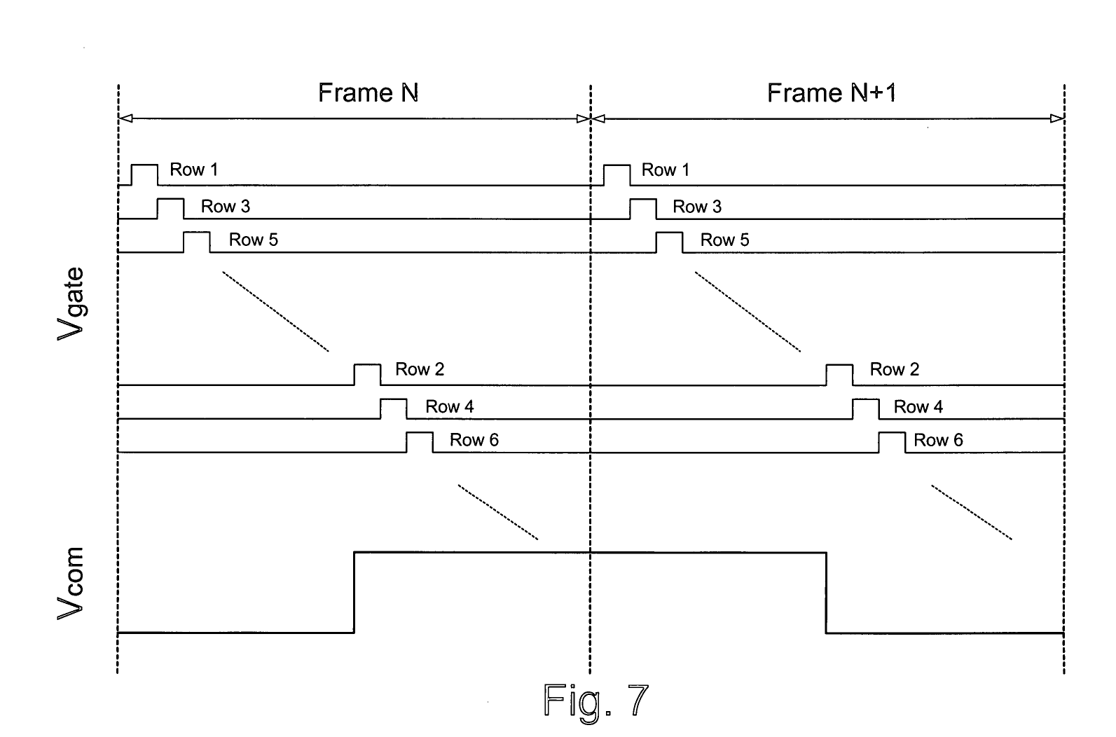

The present invention uses a different scanning method for allowing the gate line signals to drive the pixel rows. As shown in FIGS. 6 and 7, in the first half of a frame, only the odd-number rows are driven by the gate line signals in a sequential manner. In the second half of the frame, the even-number rows are driven in a sequential manner. As such, the common line voltage is required to change only once at the middle of the frame. However, because it is desirable to change the polarity of the same row of pixels in the frame between two adjacent frames, as shown in FIG. 8, the polarity of the Vcom waveform is required to flip once between two consecutive frames. Thus, effectively, the waveform of the common line voltage to achieve the row inversion scheme, according to the present invention, is the same as the waveform of the common line to achieve a prior art frame inversion scheme (see FIGS. 5 and 8).

With the scanning method, according to the present invention, it is possible to substantially reduce the frequency of the Vcom swing without having the flickering problem associated with the frame inversion scheme.

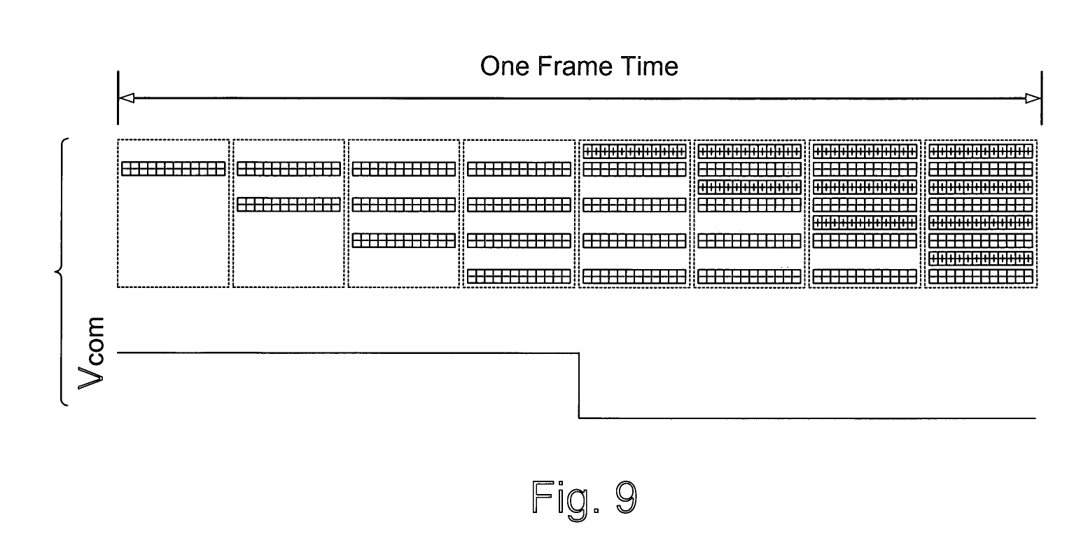

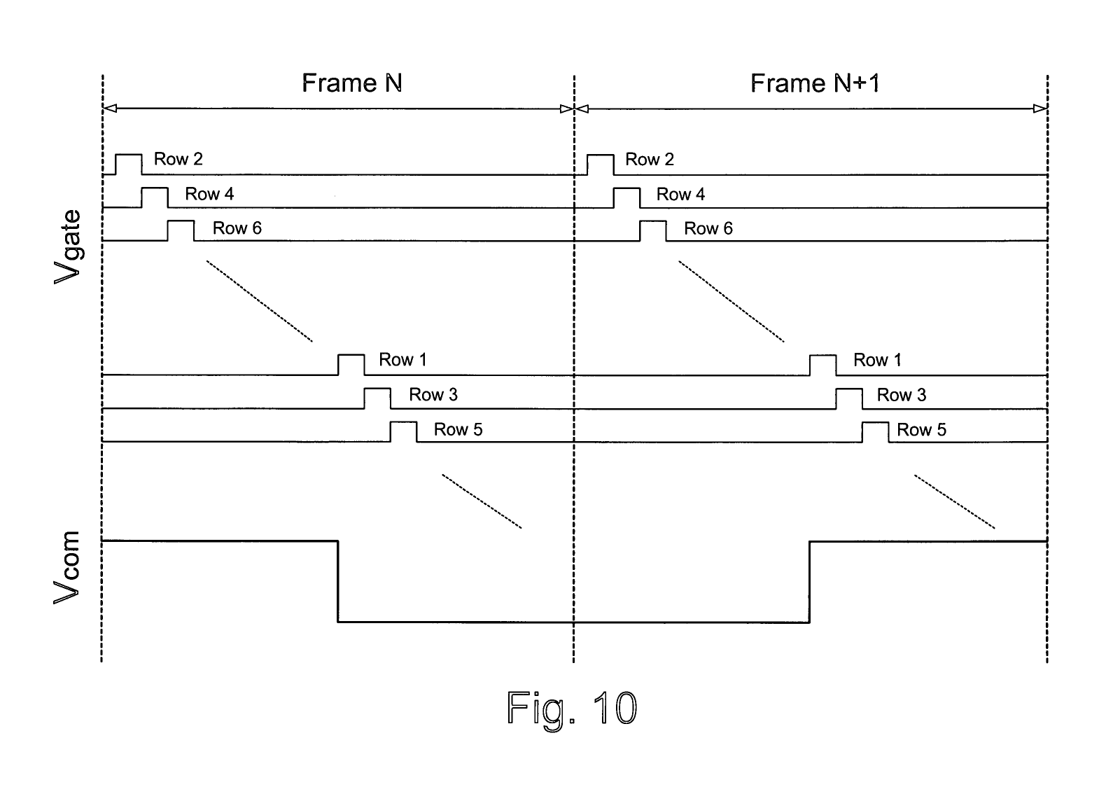

A different embodiment of the present invention is shown in FIGS. 9 and 10. As shown, in the first half of a frame, only the even-number rows are driven by the gate line signals in a sequential manner. In the second half of the frame, the odd-number rows are driven in a sequential manner.

In sum, the present invention provides a new method of achieving a row inversion effect. Instead of changing the Vcom voltage level M times per frame in order to achieve a row inversion effect in an LCD display having M rows, the same row inversion effect can be achieved by changing the Vcom voltage level only once per frame time. Thus, the Vcom frequency f is equal to the frame refreshing rate. As Vcom is provided to the LCD panel for driving the pixels, the voltage swing between two polarities may partially or fully charge some parasitic capacitance in each of the pixels.

When the control elements in the LCD panel are made of low-temperature poly-silicon (LTPS), additional parasitic capacitance may exist between the Vdd, Vss electrodes of the switching elements in the lower substrate and the common lines on the upper substrate. By reducing the Vcom swing frequency, the power consumption associated with the parasitic capacitance can be substantially reduced.

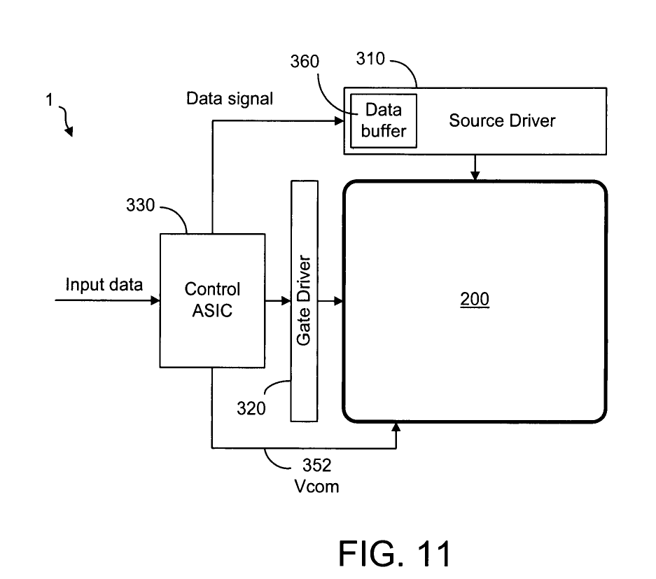

An exemplary liquid crystal display module, according to the present invention, is shown in FIG. 11. As shown in FIG. 11, the liquid crystal display module 1 includes a liquid crystal display panel 200 and a driving circuit for driving the liquid crystal display panel. The driving circuit includes one or more source driver ICs 310 to provide image data to the display panel; one or more gate drivers 330 to provide driving signals for driving the pixel rows; and a control ASIC 330 to control both source driver ICs and the gate drivers. The control ASIC 330 also provides the common voltage Vcom on common line 352.

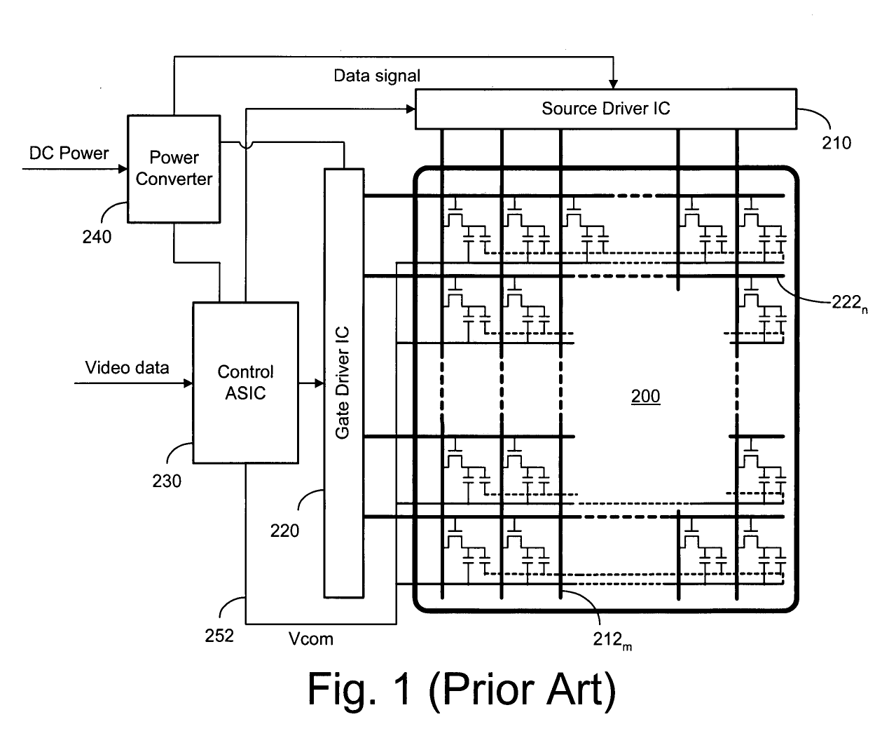

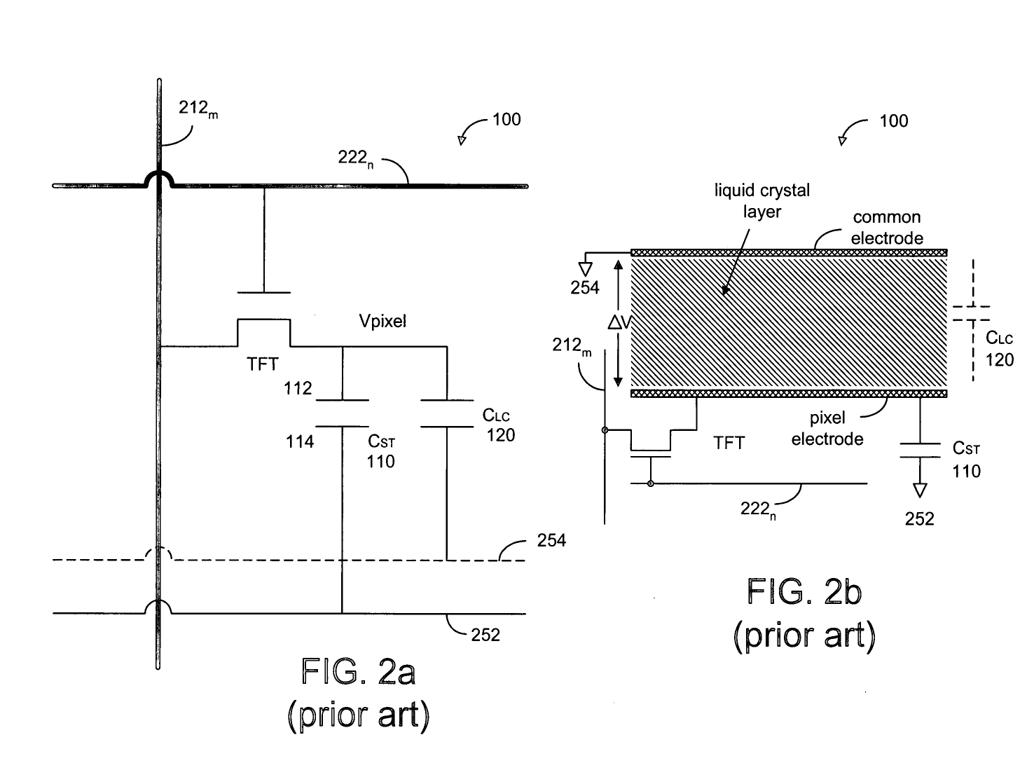

In general, the input data to the LCD panel is provided to a video rate in compliance to a certain video standard, such as NTSC. As such, the control ASIC conveys the video data for the pixel rows to the source driver IC (see FIG. 1) in a sequential manner and a gate line signal is provided to one row at a time in the same sequential manner. In order to facilitate the row inversion scheme, according to the present invention, the video data in compliance to an existing video standard must be stored in a video buffer so that the video data can be provided to the source driver IC in a non-consecutive fashion. As shown in FIG. 11, a data buffer 360 is used to temporarily store at least one frame of video data. The data buffer 360 can be integrated into the source driver ICs 310, for example. However, it is also possible to separate the data buffer 360 from the source driver ICs 310. Furthermore, the gate driver must be designed in order to achieve a different row-scanning scheme.

It should be noted that it is also possible to change the polarity of the same row of pixels in the frame every two or more frame times, instead of changing the polarity every frame time. As such, the Vcom swing frequency can be further reduced. Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method to achieve row inversion in a liquid crystal display panel for displaying images in a series of frames each at a frame time, the frame time substantially divided into a first half-frame time and a second half-frame time, the display panel having a plurality of pixels arranged in a plurality of rows driven by a series of signals, said plurality of rows including a plurality of odd-numbered rows and a plurality of even-numbered rows, wherein the display panel has a liquid crystal layer and each of the pixels has a voltage potential affecting the liquid crystal layer substantially within the pixel, and the voltage potential is controllable by a common voltage having at least a first voltage value and a second voltage value, said method comprising the steps of:
applying the common voltage to the liquid crystal display panel at a first voltage value in one of the first and second half-frame times; and
applying the common voltage to the liquid crystal display panel at a second voltage value in the other of the first and second half-frame times, such that the odd-numbered rows are driven sequentially by the signals while the common voltage has one of the first and second voltage values, and the even-numbered rows are driven sequentially by the signals while the common voltage has the other of the first and second voltage values.

2. The method of claim 1, wherein the series of frames comprises a plurality of adjacent frame pairs, each adjacent frame pair having a first frame and a second frame, and the common voltage applied to the liquid crystal panel has a voltage pattern such that
the common voltage has the first voltage value in the first half-frame time, and
the common voltage has the second voltage value in the second-half-frame time, said method further comprising the step of:
changing the voltage pattern in the second frame so that
the common voltage has the second voltage value in the first half-frame time, and
the common voltage has the first voltage value in the second half-frame time.

3. The method of claim 2, wherein the odd-numbered rows are driven sequentially by the signals in the first half-frame time and the even-numbered rows are driven sequentially by the signals in the second half-frame time.

4. The method of claim 2, wherein the even-numbered rows are driven sequentially by the signals in the first half-frame time and the odd-numbered rows are driven sequentially by the signals in the second half-frame time.

5. The method of claim 1, wherein the series of frames comprises a plurality of adjacent frame pairs, each adjacent frame pair having a first frame and a second frame, and the common voltage applied to the liquid crystal panel has a voltage pattern such that
the common voltage has the second voltage value in the first half-frame time, and
the common voltage has the first voltage value in the second half-frame time, said method further comprising the step of:
changing the voltage pattern in the second frame so that
the common voltage has the first voltage value in the first half-frame time, and
the common voltage has the second voltage value in the second half-frame time.

6. A liquid crystal display panel for displaying images in a series of frames each at a frame time, the frame time substantially divided into a first half-frame time and a second half-frame time, said display panel comprising:
a first electrode layer;
a second electrode layer; and
a liquid crystal layer disposed between the first and second electrode layer, the liquid crystal layer defining a plurality of pixels arranged in a plurality of rows, the plurality of rows including a plurality of odd-numbered pixels and a plurality of even-numbered pixels, each of the pixels having a voltage potential affecting the liquid crystal layer substantially within the pixel, and the voltage potential is controllable by a common voltage operatively connected to the first electrode layer, the common voltage having at least a first voltage value and a second voltage value, wherein
the common voltage is applied to the liquid crystal display panel at a first voltage value in one of the first and second half-frame times; and
the common voltage is applied to the liquid crystal display panel at a second voltage value in the other of the first and second half-frame times, such that the odd-numbered rows are driven sequentially by the signals while the common voltage has one of the first and second voltage values, and the even-numbered rows are driven sequentially by the signals while the common voltage has the other of the first and second voltage values.

7. The liquid crystal panel of claim 6, wherein the series of frames comprises a plurality of adjacent frame pairs, each adjacent frame pair having a first frame and a second frame, and wherein
the common voltage has the first voltage value in the first half-frame time of the first frame,
the common voltage has the second voltage value in the second half-frame time of the first frame,
the common voltage has the second voltage value in the first half-frame time of the second frame, and
the common voltage has the first voltage value in the second half-frame time of the second frame.

8. The liquid crystal panel of claim 7, wherein the odd-numbered rows are driven sequentially by the signals in the first half-frame time and the even-numbered rows are driven sequentially by the signals in the second half-frame time.

9. The liquid crystal panel of claim 7, wherein the even-numbered rows are driven sequentially by the signals in the first half-frame time and the odd-numbered rows are driven sequentially by the signals in the second half-frame time.

10. A driving module for use with a liquid crystal display panel for displaying images in a series of frames each at a frame time, the frame time substantially divided into a first half-frame time and a second half-frame time, said display panel comprising:
a first electrode layer;
a second electrode layer; and
a liquid crystal layer disposed between the first and second electrode layer, the liquid crystal layer defining a plurality of pixels arranged in a plurality of rows, the plurality of rows including a plurality of odd-numbered pixels and a plurality of even-numbered pixels, each of the pixels having a voltage potential affecting the liquid crystal layer substantially within the pixel, said driving module comprising:
a data sub-module for providing image data to the pixels;
a driving sub-module for providing a series of signals to drive the pixel rows; and
a control sub-module for providing a common voltage to the first electrode layer for controlling the voltage potential, the common voltage having at least a first voltage value and a second voltage value, such that
the common voltage is applied to the liquid crystal display panel at a first voltage value in one of the first and second half-frame times; and
the common voltage is applied to the liquid crystal display panel at a second voltage value in the other of the first and second half-frame times, so that the odd-numbered rows are driven sequentially by the signals while the common voltage has one of the first and second voltage values, and the even-numbered rows are driven sequentially by the signals while the common voltage has the other of the first and second voltage values.

11. The driving module of claim 10, wherein the series of frames comprises a plurality of adjacent frame pairs, each adjacent frame pair having a first frame and a second frame, and wherein
the common voltage has the first voltage value in the first half-frame time of the first frame,
the common voltage has the second voltage value in the second half-frame time of the first frame,
the common voltage has the second voltage value in the first half-frame time of the second frame, and
the common voltage has the first voltage value in the second half-frame time of the second frame.

12. The driving module of claim 11, wherein the odd-numbered rows are driven sequentially by the signals in the first half-frame time and the even-numbered rows are driven sequentially by the signals in the second half-frame time.

13. The driving module of claim 11, wherein the even-numbered rows are driven sequentially by the signals in the first half-frame time and the odd-numbered rows are driven sequentially by the signals in the second half-frame time.
